(19) United States
(12) Patent Application Publication
(10) Pub. No.: US 2024/0396803 A1
(43) Pub. Date: Nov. 28, 2024

(54) METHOD FOR NETWORK CONNECTION WITH HIGH AVAILABILITY AND ELECTRONIC DEVICE USING THE SAME

(71) Applicant: NetLOX Co., Ltd., Seongnam-si (KR)

(72) Inventors: Seok Hwan KONG, Yongin-si (KR); Dipjyoti SAIKIA, Yongin-si (KR); Nikhil MALIK, Seongnam-si (KR); Baek Gyun JUNG, Seongnam-si (KR); Ren Hao CHU, Seongnam-si (KR)

(73) Assignee: NetLOX Co., Ltd., Seongnam-si (KR)

(21) Appl. No.: 18/391,425

(22) Filed: Dec. 20, 2023

(30) Foreign Application Priority Data
May 24, 2023 (KR) 10-2023-0067246

(51) Int. Cl. H04L 41/12

(52) U.S. Cl. CPC H04L 41/12; H04L 67/1095

(57) ABSTRACT

According to various embodiments, an electronic device may include an operation of receiving, by a first eBPF module, untracked new traffic from a client; an operation of adding, by the first eBPF module, an entry corresponding to the new traffic to a Conn Track map in response to the operation of receiving the new traffic; an operation of reporting, by the first eBPF module, the addition of the entry to a first synchronization module; and an operation of monitoring, by the first synchronization module, a first connection corresponding to the new traffic. Other embodiments are also available.

### TECHNICAL FIELD

Various embodiments of the present invention relate to a high-availability network connection method and an electronic device using the same.

### BACKGROUND ART

In today's fourth industries as a topic, a vast amount of data can be hyper-connected through various devices. In such an environment, innovative convergence new product and service solution markets may be expanded, which reflect user's needs, and constructing a network infrastructure capable of processing various data without loss for this can be required.

### DISCLOSURE

### Technical Problem

By using an eBPF, packet connection information between load balancers is synchronized, and each connection state is monitored, and the load balancer can be used so that a connection state can be maintained. Further, a master node of a cloud may control the load balancer, and control a packet connection between the cloud and an external network. Through this, a high-availability network system may be constructed.

### Technical Solution

According to various embodiments, the method of the electronic device may include an operation of receiving, by a first eBPF module, untracked new traffic from a client; an operation of adding, by the first eBPF module, an entry corresponding to the new traffic to a ConnTrack map in response to the operation of receiving the new traffic; an operation of reporting, by the first eBPF module, the addition of the entry to a first synchronization module; and an operation of monitoring, by the first synchronization module, a first connection corresponding to the new traffic.

According to various embodiments, a method of the external electronic device may include an operation of receiving first connection information from the first synchronization module of the electronic device in the cluster through a second synchronization module of the external electronic device; an operation of requesting, by the second synchronization module, the second eBPF module of the external electronic device to update the first connection information to a Conntrack map of the external electronic device; and an operation of updating, by the second eBPF module, the first connection information to the Conntrack map.

According to various embodiments, a cluster system including a client, an electronic device, an external electronic device, and a cloud server may include: an operation of receiving, by the electronic device, untracked new traffic from the client; an operation of adding, by the electronic device, an entry corresponding to the new traffic; an operation of transmitting, by the electronic device, connection information corresponding to the entry to the external electronic device; and an operation of storing, by the external electronic device, the connection information, and synchronizing with the electronic device.

### ADVANTAGEOUS EFFECTS

According to various embodiments of the present invention, the load balancer can synchronize packet connection information between respective load balancers by using an eBPF, monitor each connection state, and can be used so that a connection state can be maintained. Further, a master node of a cloud can control the load balancer, and control a packet connection between the cloud and an external network. Through this, a high-availability network system can be constructed.

### DESCRIPTION OF DRAWINGS

FIG. 1 is a block diagram of an electronic device in a network environment according to various embodiments of the present invention.

FIG. 2 is a diagram for a high-availability network system according to various embodiments of the present invention.

FIG. 3 is a diagram schematically illustrating a load balancer according to various embodiments of the present invention.

FIG. 4 is a diagram illustrating a method for tracking a new connection of the load balancer according to various embodiments of the present invention.

FIG. 5 is a diagram illustrating a method for synchronizing, with another load balancer, the load balancer according to various embodiments of the present invention.

FIG. 6 is a diagram schematically illustrating a traffic flow of a first load balancer according to various embodiments of the present invention.

FIG. 7 is a diagram schematically illustrating a traffic flow of a second load balancer according to various embodiments of the present invention.

FIG. 8 is a diagram illustrating a high-availability network connection of a network system according to various embodiments of the present invention.

FIG. 9 is a diagram illustrating a conventional network system.

FIG. 10 is a diagram illustrating a network system using an eBPF according to various embodiments of the present invention.

### MODE FOR INVENTION

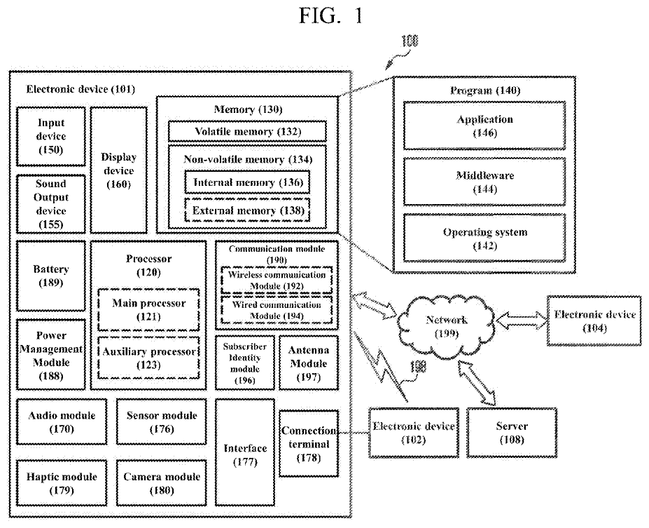

FIG. 1 is a block diagram of an electronic device 101 in a network environment 100 according to various embodiments of the present invention. Referring to FIG. 1, in the network environment 100, the electronic device 101 may communicate with an electronic device 102 through a first network 198 (e.g., a short-range wireless communication network) or communicate with an electronic device 104 or a server 108 through a second network 199 (e.g., a long-range wireless communication network). According to an embodiment, the electronic device 101 may communicate with the electronic device 104 through the server 108. According to an embodiment, the electronic device 101 may include a processor 120, a memory 130, an input device 150, a sound output device 155, a display device 160, an audio module 170, a sensor module 176, an interface 177, a haptic module 179, a camera module 180, a power management module 188, a battery 189, a communication module 190, a subscriber identification module 196, or an antenna module 197. In some embodiments, at least one (e.g., display device 160 or camera module 180) of the components may be omitted from or one or more other components may be added to the electronic device 101. In some embodiments, some of the components may be implemented as one integrated circuit. For example, the sensor module 176 (e.g., a fingerprint sensor, an iris sensor, or an illuminance sensor) may be implemented while being embedded in the display device 160 (e.g., a display).

For example, the processor 120 executes software (e.g. the program 140) to control at least one other component (e.g., a hardware or software component) of the electronic device 101 connected to the processor 120 and perform various data processing or operations. According to an embodiment, as at least some of the data processing or operations, the processor 120 may load, to a volatile memory 132, commands or data received from other components (e.g., the sensor module 176 or the communication module 190), process the commands or data stored in the volatile memory 132, and store result data in a non-volatile memory 134. According to an embodiment, the processor 120 may include a main processor 121 (e.g., a central processing unit or an application processor) and an auxiliary processor 123 (e.g., a graphic processing unit, an image signal processor, a sensor hub processor, or a communication processor) which is operable independently from or together with the main processor 121. Additionally or alternatively, the auxiliary processor 123 may be set to use lower power than the main processor 121 or to be specialized to a specified function. The auxiliary processor 123 may be implemented separately from the main processor 121 or as a part of the main processor 121.

The auxiliary processor 123 may control at least some of functions or states related to at least one component (e.g., the display device 160, the sensor module 176, or the communication module 190) of the components of the electronic device 101 instead of the main processor 121 while the main processor 121 is in an inactive (e.g., sleep) state or together with the main processor 121 while the main processor 121 is in an active (e.g., application execution) state, for example. According to an embodiment, the auxiliary processor 123 (e.g., an image signal processor or a communication processor) may be implemented as a part of another component (e.g., the camera module 180 or the communication module 190) which is functionally related.

The memory 130 may store various data used by at least one component (e.g., the processor 120 or the sensor module 176) of the electronic device 101. The data may include, for example, software (e.g., the program 140) and input data or output data for a command related to the software. The memory 130 may include the volatile memory 132 or the non-volatile memory 134.

The program 140 may be stored in the memory 130 as the software, and may include, for example, an operating system 142, middleware 144, or an application 146.

The input device 150 may receive the command or data to be used for the component (e.g., the processor 120) of the electronic device 101 from the outside (e.g., a user) of the electronic device 101. The input device 150 may include, for example, a microphone, a mouse, or a keyboard.

The sound output device 155 may output a sound signal to the outside of the electronic device 101. The sound output device 155 may include, for example, a speaker or a receiver. The speaker may be used for a general purpose such as multimedia reproduction or recording reproduction, and the receiver may be used for receiving an incoming call. According to an embodiment, the receiver may be implemented separately from the speaker or as a part of the speaker.

The display device 160 may visually provide information to the outside (e.g., the user) of the electronic device 101. The display device 160 may include, for example, a display, a hologram device, or a projector and a control circuit for controlling the corresponding device. According to an embodiment, the display device 160 may include a touch circuitry set to sense a touch or a sensor circuitry (e.g., a pressure sensor) set to measure an intensity of force generated by the touch.

The audio module 170 may convert a sound into an electric signal and reversely, convert the electric signal into the sound. According to an embodiment, the audio module 170 may acquire the sound through the input device 150 or output the sound through an external electronic device (e.g., the electronic device 102) (e.g., the speaker or a headphone) directly or wirelessly connected to the sound output device 155 or the electronic device 101.

The sensor module 176 may sense an operation state (e.g., power or temperature) of the electronic device 101 or an external environmental state (e.g., a user state) and generate an electric signal or a data value corresponding to the sensed state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biosensor, a temperature sensor, a humidity sensor, or an illuminance sensor.

The interface 177 may support one or more designated protocols which may be used for the electronic device 101 to be directly or wirelessly connected to the external electronic device (e.g., the electronic device 102). According to an embodiment, the interface 177 may include, for example, a high definition multimedia interface (HDMI), a universal serial bus (USB) interface, an SD card interface, or an audio interface.

A connection terminal 178 may include a connector for the electronic device 101 to be physically connected to the external electronic device (e.g. the electronic device 102) through the interface 177. According to an embodiment, the connection terminal 178 may include, for example, an HDMI connector, a USB connector, an SD card connector, or an audio connector (e.g., a headphone connector).

The haptic module 179 may convert the electric signal into a mechanical stimulus (e.g., vibration or motion) or an electrical stimulus which the user may recognize through a tactile or exercise sensation. According to an embodiment, the haptic module 179 may include, for example, a motor, a piezoelectric element, or an electrical stimulus device.

The camera module 180 may photograph a still image and a moving picture. According to an embodiment, the camera module 180 may include one or more lenses, image sensors, image signal processors, or flashes.

The power management module 188 may manage power supplied to the electronic device 101. According to an embodiment, the power management module 188 may be implemented as at least a part of a power management integrated circuit (PMIC), for example.

The battery 189 may provide power to at least one component of the electronic device 101. According to an embodiment, the battery 189 may include, for example, a non-rechargeable primary battery, a rechargeable secondary battery, or a fuel cell.

The communication module 190 may support establishment of a direct (e.g., wired) communication channel or a wireless communication channel between the electronic device 101 and the external electronic device (e.g., the electronic device 102, the electronic device 104, or the server 108) and communication execution through the established communication channel. The communication module 190 may include one or more communication processors which are operated independently from the processor 120 (e.g., the application processor) and support direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication module). A corresponding communication module of the communication modules may communicate with the external electronic device through a first network 198 (e.g., a short-range communication network such as Bluetooth, Wi-Fi direct or infrared data association (IrDA)) or a second network 199 (e.g., a long-range communication network such as a cellular network, the Internet, or a computer network (e.g., LAN or WAN)). The types of communication modules may be integrated into one component (e.g., single chip), or may be implemented as a plurality of separate components (e.g., plural chips). The wireless communication module 192 may check and authenticate the electronic device 101 in the communication network such as the first network 198 or the second network 199 by using subscriber information (e.g., international mobile subscriber identity (IMSI)) stored in the subscriber identification module 196.

The antenna module 197 may transmit the signal or power to the outside (e.g., the external electronic device) or receive the signal or power from the outside. According to an embodiment, the antenna module 197 may include one or more antennas, and therefrom, at least one antenna suitable for a communication scheme used in the communication network such as the first network 198 or the second network 199 may be selected by the communication module 190, for example. The signal or power may be transmitted or received between the communication module 190 and the external electronic device through the at least one selected antenna.

At least some of the components may be connected to each other through a communication scheme (e.g., a bus, a general purpose input and output (GPIO), a serial peripheral interface (SPI), or a mobile industry processor interface (MIPI)) between peripheral machines and exchange the signal (e.g., command or data) with each other.

According to an embodiment, the command or data may be transmitted or received between the electronic device 101 and the external electronic device 104 through the server 108 connected to the second network 199. The respective electronic devices 102 and 104 may be devices of the same type as or different types from the electronic device 101. According to an embodiment, all or some of the operations executed in the electronic device 101 may be executed in one or more external devices of the external electronic devices 102, 104, or 108. For example, when the electronic device 101 should perform any function or service automatically or in response to a request from the user or another device, the electronic device 101 may request one or more external electronic devices to perform at least a part of the function or service instead of or in addition to autonomously executing the function or service. One or more external electronic devices receiving the request may execute at least a part of the requested function or service or an additional function or service related to the request, and transfer a result of the execution to the electronic device 101. The electronic device 101 may process the result as it is or additionally, and provide the processed result as at least a part of a response to the request. To this end, for example, cloud computing, distributed computing, or client-server computing technology may be used.

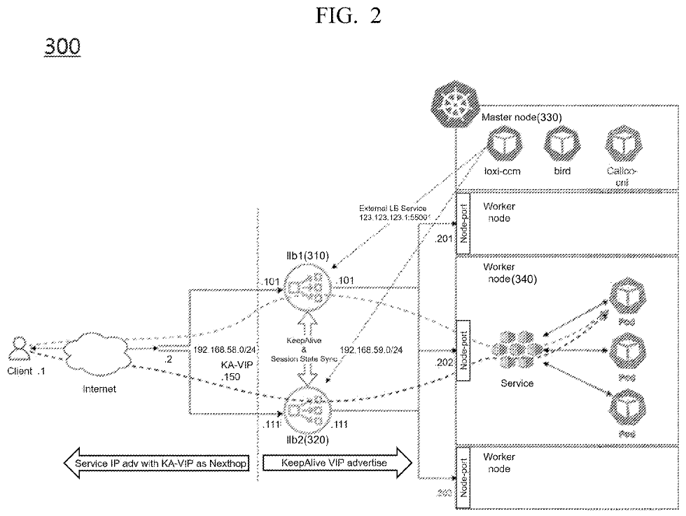

FIG. 2 is a block diagram 200 of the program 140 according to various According to an embodiment, the program 140 may include an operating embodiments. system 142 for controlling one or more resources of the electronic device 101, middleware 144, or an application 146 executable in the operating system 142. The operating system 142 may include, for example, Android™, iOS™, Windows™, Symbian™, Tizen™, or Bada™. At least some programs in the programs 140 may, for example, pre-loaded to the electronic device 101 upon manufacturing or downloaded or updated from an external electronic device (e.g., the electronic device 102 or 104, or the server 108) in a use environment of a user.

The operating system 142 may control (e.g., allocate or recover) a system resource (e.g., a process, a memory, or a power supply) of the electronic device 101. The operating system 142 may additionally or alternatively include one or more driver programs for driving other hardware devices of the electronic device 101, for example, the input device 150, the sound output device 155, the display device 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 so as for the application 146 to use functions or information provided by one or more resources of the electronic device 101. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227. The application manager 201 may manage a life cycle of the application 146, for example. The window manager 203 may manage a GUI resource used on a screen, for example. The multimedia manager 205 may determine a format required for playing media files, and perform encoding or decoding of the media file by using a codec suitable for the format, for example. The resource manager 207 may manage a source code of the application 146 or a space of the memory, for example. The power manager 209 may manage a capacity, a temperature, or a power of the battery, and determine or provide power information required for an operation of the electronic device 101 using the information among them, for example. According to an embodiment, the power manager 209 may interlock with a basic input/output system (BIOS).

The database manager 211 may generate, search, or change a database to be used in the application 146, for example. The package manager 213 may manage installation or update of an application distributed in the form of a package file, for example. The connectivity manager 215 may manage wireless or wired connection between the electronic device 101 and the external electronic device, for example. The notification manager 217 may provide a function for notifying a generated event (e.g., a telephony, a message, or an alarm) to the user, for example. The location manager 219 may manage positional information of the electronic device 101, for example. The graphic manager 221 may manage a graphic effect to be provided to the user or a user interface related thereto, for example. The security manager 223 may provide a system security or a user authentication, for example. The telephony manager 225 may manage a voice telephony or video telephony function of the electronic device 101, for example. The voice recognition manager 227 may transmit voice data of the user to the server 108, and receive a command corresponding to a function to be performed in the electronic device 101 based on the voice data or text data converted based on the voice data. According to an embodiment, the middleware 144 may dynamically delete some of the existing components or add new components. According to an embodiment, at least a part of the middleware 144 may be included in a part of the operating system 142 or implemented as separate software from the operating system 142.

The application 146 may include, for example, a home 251, dialer 253, SMS/MMS 255, instant message (IM) 257, browser 259, camera 261, alarm 263, contact 265, voice recognition 267, e-mail 269, calendar 271, media player 273, album 275, watch 277, health 279 (e.g., measuring an exercise amount, a blood sugar, or the like), or environmental information 281 (e.g., air pressure, humidity, or temperature information) application. According to an embodiment, the application 146 may further include an information exchange application (not illustrated) that may support information exchange between the electronic device 101 and the external electronic device. The information exchange application may include, for example, a notification relay application for relaying designated information (e.g., the telephony, the message or the alarm) to the external electronic device or a device management application for managing the external electronic device. The notification relay application may relay notification information corresponding to an event (e.g., e-mail reception) generated in another application (e.g., the e-mail application 269) of the electronic device 101 to the external electronic device, or receive the notification information from the external electronic device and provide the notification information to the user of the electronic device 101, for example. The device management application may control a power (e.g., turn-on or turn-off) or a function (e.g., brightness, resolution, or focus of the display device 160 or the camera module 180) of the external electronic device which communicates with the electronic device 101 or some components (e.g., the display device 160 or the camera module 180) thereof, for example. The device management application may additionally or alternatively support installation, deletion, or update of the application which operates in the external electronic device.

The electronic devices according to various embodiments disclosed in this document may become various types of devices. The electronic device may include, for example, a portable communication device (e.g., a smartphone), a computer device, a portable multimedia device, a portable medical machine, a camera, a wearable device, or a home appliance device. The electronic device according to the embodiment of this document is not limited to the above-described machines.

Various embodiments of this document and terms used therein are not intended to limit technical features described in this document to specific embodiments, and it should be understood that various embodiments and the terms include various modifications, equivalents, or substitutes for the corresponding embodiment. In connection with the description of the drawings, similar reference numerals may be used for similar or related components. A singular type of a noun corresponding to an item may include one or a plurality of items unless a related context is apparently differently indicated. In this document, each of phrases such as “A or B”, “at least one of A and B”, “at least one of A or B”, “A, B, or C”, “at least one of A, B, and C”, and “at least one of A, B, or C” may include all possible combinations of items listed together with a corresponding phrase among the phrases. Terms such as “first” or “second” may be just used to distinguish a corresponding component from the other corresponding component and the corresponding components are not limited in other aspects (e.g., importance or order). When it is mentioned that any (e.g., first) component is “coupled” or “connected” to the other (e.g., second) component together with a term “functionally” or “communicationally” or without the term, it means that the any component can be connected to the other component directly (e.g., by wire), wirelessly, or through a third component.

The term “module” used in this document may include a unit implemented as hardware, software, or firmware, and may be used inter-compatibly with a term such as logic, a logic block, a part, or a circuit, for example. The module may become an integrally configured part or a minimum unit or a part of the part, which performs one or more functions. For example, according to an embodiment, the module may be implemented in the form of an application-specific integrated circuit (ASIC).

Various embodiments of this document may be implemented as software (e.g., the program 140) including one or more commands stored in a storage medium (e.g., an internal memory 136 or an external memory 138) readable by a machine (e.g., the electronic device 101). For example, the processor (e.g., the processor 120) of the machine (e.g., the electronic device 101) may call at least one command of one or more stored commands from the storage medium and execute the called command. This enables the machine to be operated to perform at least one function according to the at least one called command. The one or more commands may include a code generated by a compiler or a code executable by an interpreter. The storage medium readable by the machine may be provided as a form of a non-transitory storage medium. Here, ‘non-transitory’ just means that the storage medium is a tangible device and does not include a signal (e.g., an electromagnetic wave), and this term does not distinguish a case where data is semi-persistently stored in the storage medium and a case where the data is temporarily stored.

According to an embodiment, a method according to various embodiments disclosed in this document may be provided while being included in a computer program product. The computer program products may be traded between a seller and a purchaser as merchandise. The computer program products may be distributed in the form of a machine-readable storage medium (e.g., compact disc read only memory (CD-ROM)) or distributed (e.g., downloaded or uploaded) online directly through an application store (e.g., Play Store™) or between two user devices (e.g., smartphones). In the case of online distribution, at least some of the computer program products may be at least transitorily stored in a machine-readable storage medium such as a server of a manufacturer, a server of the application store, or a memory of a relay server, or temporarily generated.

According to various embodiments, each component (e.g., a module or program) of the above-described components may include a single or a plurality of entities. According to various embodiments, one or more components or operations of the above-described components may be omitted, or one or more other components or operations may be added. Alternatively or additionally, the plurality of components (e.g., the module or program) may be integrated into one component. In this case, the integrated component may perform one or more functions of respective components of the plurality of components in the same or similar manner as performing the function by the corresponding component of the plurality of components before the integration. According to various embodiments, operations performed by modules, programs, or other components may be executed sequentially, in parallel, repeatedly, or heuristically, or one or more of the above operations may be executed in different orders or omitted, or one or more other operations may be added.

FIG. 2 is a diagram for a high-availability network system according to various embodiments of the present invention.

According to various embodiments, a high-availability network system 300 may include a first load balancer 310, a second load balancer 320, a master node 330, and a worker node 340.

According to various embodiments, a load balancer may mean a device that distributes a load applied to a cloud server, a load applied to an end of the network, or all loads applied to the ends of the cloud server and the network. For example, the load balancer may synchronize packet connection information between respective load balancers, and monitor each connection state to continuously maintain the connection state (high availability). For example, the load balancer is positioned between the client and the cloud server, and manages traffic to prevent the load from being concentrated on one server to enable each server to show an optimal performance. For example, the load balancer may be used in a distribution processing system which has multiple servers and provides a network service. For example, the load balancer may reuse a connection generated by activating keep-alive. A resource is consumed to cut a pre-generated connection, so the cost is reduced to achieve quicker communication.

According to various embodiments, a cloud controller manager (CCM) 330 may control the connection state between the cloud server and the load balancer in the master node. For example, the cloud controller manager 330 may correspond to a Loxi-ccm solution. For example, the cloud controller manager 330 may serve as a brain of a cluster constituted by multiple servers, and perform tasks including container scheduling, service management, API request processing, etc.

According to various embodiments, a node component 340 may manage a container runtime and monitor a state in order to execute a work load reserved in the node, in the worker node. The node component 340 may route communication between pods in different nodes and network traffic between the pod and the Internet in the worker node. The node component 340 may start or stop a container, and process inter-container communication, in the worker node.

According to various embodiments, the pod may correspond to a basic task unit in a cluster, and designate a single container or container group to be scheduled.

According to various embodiments, a service may route traffic to the corresponding pod through an IP address or a DNS name in the cluster.

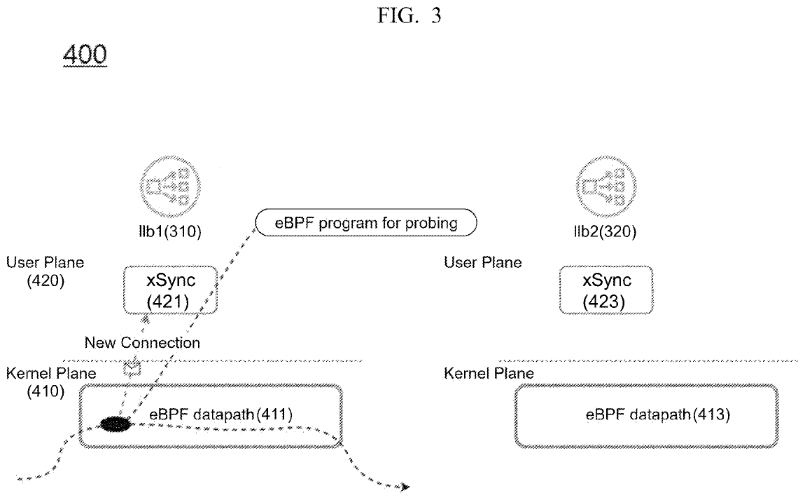

FIG. 3 is a diagram schematically illustrating a load balancer according to various embodiments of the present invention.

According to various embodiments, the first load balancer 310 may include a first eBPF module 411 of a kernel plane 410 and a first synchronization module 421 of a user plane 420. For example, an eBPF module may mean an extended Berkeley Packet Filter module, and mean technology that applies a user-defined code on a kernel. The eBPF module may execute a code created by a user in a kernel plane based on hook or kprobe, uprobe, tracepoint, etc., predefined in a kernel code.

According to various embodiments, the second load balancer 320 may include a second eBPF module 413 of the kernel plane 410 and a second synchronization module 423 of the user plane 420.

According to various embodiments, the eBPF module may be positioned in “kprobe/htab_map_update_elem” and “kprobe/htab_map_delete_elem” in order to search an eBPF map update. For example, the eBPF module may add an entry to a CT map (ConnTrack map, a path of connection information/packet) when new untracked traffic arrives. For example, the eBPF module may report the added entry to a synchronization module of the user plane.

According to various embodiments, the synchronization module may confirm the entry through map update in the user plane 420, and filter the entry in the CT map. For example, when the new untracked traffic is tracked or established in an eBPF data path, the synchronization module may search a new untracked connection. For example, the synchronization module may update all members of the cluster once the connection is tracked.

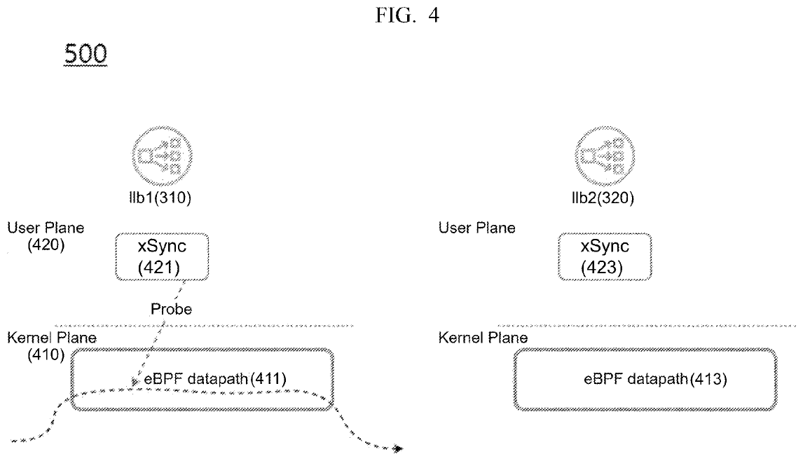

FIG. 4 is a diagram 500 illustrating a method for tracking a new connection of the load balancer according to various embodiments of the present invention.

According to various embodiments, the first synchronization module 421 of the user plane 420 may periodically search whether a newly reported untracked connection is established. For example, the first synchronization module 421 may synchronize a long-lived connection for at least 10 seconds or more. Specifically, the first synchronization module 421 may synchronize only a long-lived connection for at least 10 seconds or more.

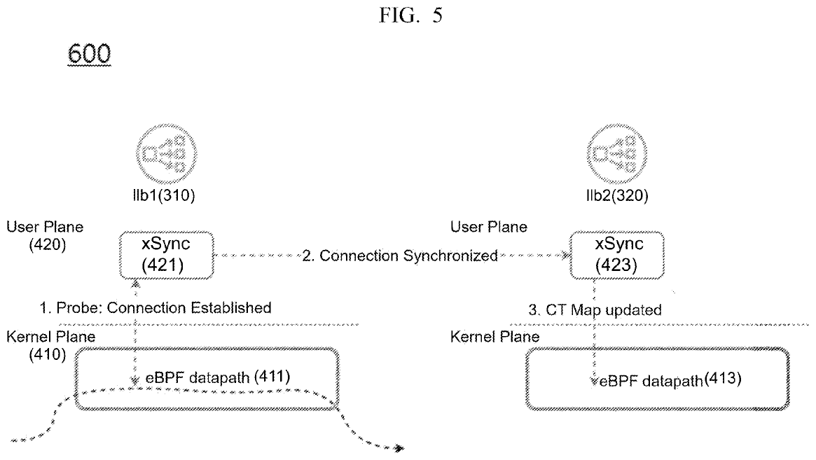

FIG. 5 is a diagram 600 illustrating a method for synchronizing, another load balancer, the load balancer according to various embodiments of the present invention.

According to various embodiments, the first synchronization module 421 of the first load balancer may confirm a new established connection from the first eBPF module 411.

According to various embodiments, the first load balancer 310 may synchronize the newly established connection with another member of the cluster including the first load balancer. For example, the first load balancer 310 may synchronize the second load balancer 320 and the newly established connection. For example, each event generated in the cluster may be updated to the CT map of the eBPF module. That is, traffic generated from the first load balancer 310 may be updated to the CT map of the second eBPF module 413 of the second load balancer 320.

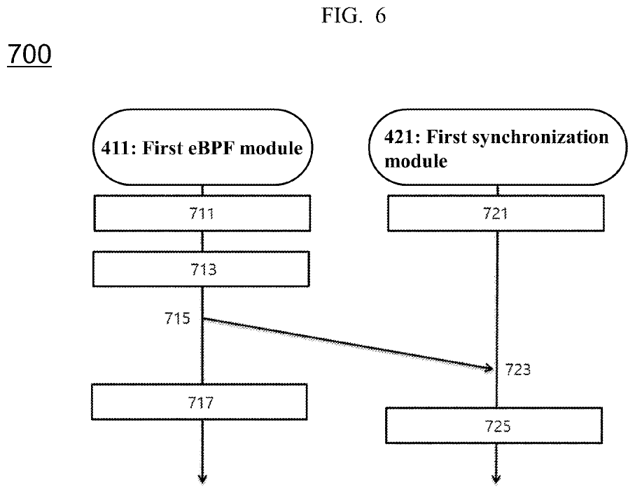

FIG. 6 is a diagram 700 schematically illustrating a traffic flow of a first load balancer according to various embodiments of the present invention.

According to various embodiments, in operation 711, the first eBPF module 411 may attach “kprobe/htab_map_update_elem” and “kprobe/htab_map_delete_elem” in order to search an eBPF map update. According to various embodiments, in operation 721, the first synchronization module 421 may configure an inter-load balancer cluster (health check).

According to various embodiments, in operation 713, the first eBPF module 411 may update connection information to the CT map when a new packet arrives. For example, the connection information may include information such as SIP, DIP, Sport, Dport, Protocol, a state, etc. For example, the state may include untracked and tracked. For example, untracked may mean that a connection is not yet established, and tracked may mean a state in which the connection is successfully established, that is, a network session is connected.

According to various embodiments, in operation 715, the first eBPF module 411 may report new connection information which is previously untracked to the first synchronization module 421. According to various embodiments, in operation 723, the first synchronization module 421 may transmit the new connection information which untracked, and periodically monitor the connection information from the first eBPF module 411. For example, the first synchronization module 421 sets a temporal condition to set only conntrack entry connected for a predetermined time or more to be periodically confirmed. For example, the first synchronization module 421 may confirm only a long-lived connection, and process a connection which is ended shortly such as rest as noise, and set only a connection for at least 10 seconds or more to be periodically confirmed.

According to various embodiments, in operation 717, the first eBPF module 411 may update the state of the new connection information based on monitoring of the first synchronization module 421. For example, the first eBPF module 411 may update the state of the new connection information from untracked to tracked.

According to various embodiments, in operation 725, the first synchronization module 421 may deliver Conntrack (CT) map information to the load balancer in the cluster. For example, ConnTrack may mean a module of Linux that manages a network connection state.

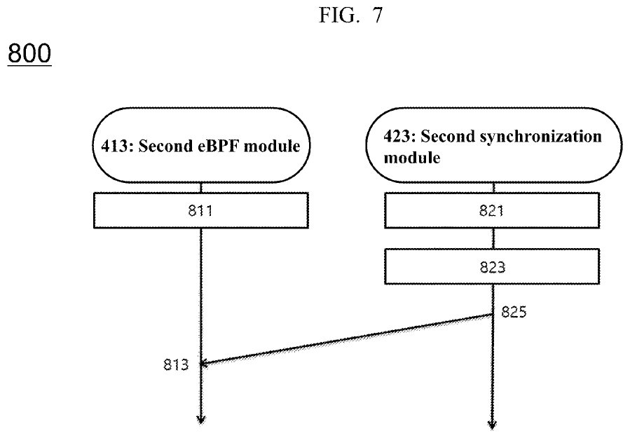

FIG. 7 is a diagram 800 schematically illustrating a traffic flow of a second load balancer according to various embodiments of the present invention.

According to various embodiments, in operation 811, the second eBPF module 413 may attach “kprobe/htab_map_update_elem” and “kprobe/htab_map_delete_elem” in order to search an eBPF map update. According to various embodiments, in operation 821, the second synchronization module 423 may configure an inter-load balancer cluster (health check).

According to various embodiments, in operation 823, the second synchronization module 423 may receive newly tracked connection information through the first synchronization module 421 of the first load balancer 310 in the cluster.

According to various embodiments, in operation 825, the second synchronization module 423 may request the second eBPF module 413 to update the CT map.

According to various embodiments, in operation 813, the second eBPF module 413 may add Conntrack of the same path in response to the request of the second synchronization module 423. That is, a synchronized session performing the same function in the cluster may be generated through a series of operations.

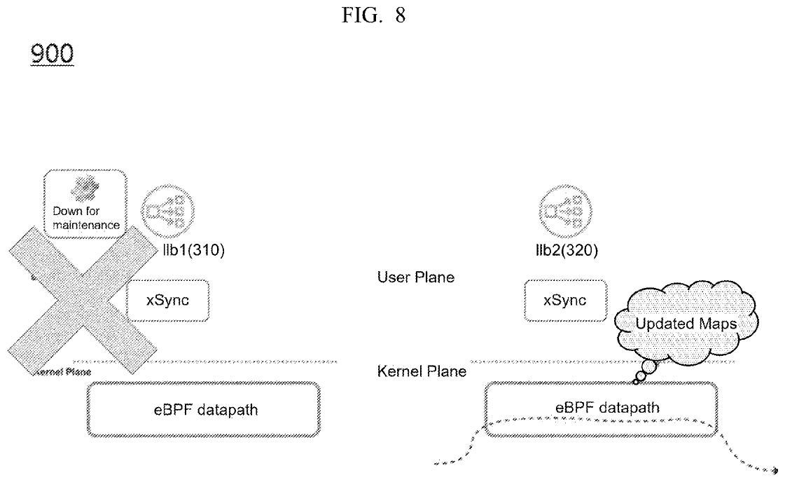

FIG. 8 is a diagram 900 illustrating a high-availability network connection of a network system according to various embodiments of the present invention.

According to various embodiments, when the first load balancer 310 in the cluster is in need of maintenance (down for maintenance), the traffic may be processed without a delay or loss by using the second load balancer 320 in the cluster.

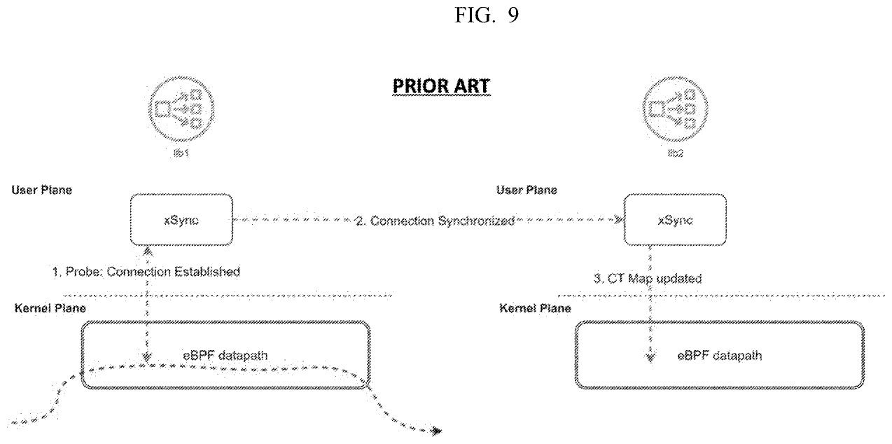

FIG. 9 is a diagram illustrating a conventional network system.

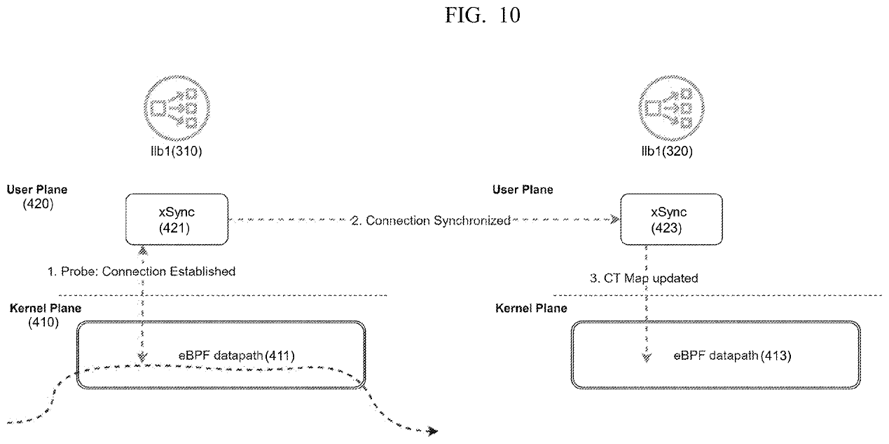

FIG. 10 is a diagram illustrating a network system using eBPF according to various embodiments of the present invention.

According to various embodiments, a connection without the delay or loss may be implemented by synchronizing the traffic through the eBPF module on the kernel plane instead of synchronization using a conventional legacy network.

According to various embodiments, the method of the electronic device may include an operation of receiving, by a first eBPF module, untracked new traffic from a client; an operation of adding, by the first eBPF module, an entry corresponding to the new traffic to a ConnTrack map in response to the operation of receiving the new traffic; an operation of reporting, by the first eBPF module, the addition of the entry to a first synchronization module; and an operation of monitoring, by the first synchronization module, a first connection corresponding to the new traffic.

The electronic device may include an operation of transmitting information corresponding to the first connection to a second synchronization module of an external electronic device through the first synchronization module.

The operation of adding the entry may include an operation of updating at least one of SIP, DIP, Sport, Dport, Protocol, or a state corresponding to the new traffic to the ConnTrack map.

The operation of monitoring may include an operation of monitoring the first connection corresponding to the new traffic when the entry is maintained for a pre-designated time or more.

The electronic device may include an operation of receiving information corresponding to a second connection of traffic different from the new traffic, from the second synchronization module of the external electronic device through the first synchronization module.

The first synchronization module may be positioned in a user plane, and the first eBPF module may be positioned in the kernel plane.

The pre-designated time may be at least 10 seconds or more.

According to various embodiments, a method of the external electronic device may include an operation of receiving first connection information from the first synchronization module of the electronic device in the cluster through a second synchronization module of the external electronic device; an operation of requesting, by the second synchronization module, the second eBPF module of the external electronic device to update the first connection information to a Conntrack map of the external electronic device; and an operation of updating, by the second eBPF module, the first connection information to the Conntrack map.

According to various embodiments, a cluster system including a client, an electronic device, an external electronic device, and a cloud server may include: an operation of receiving, by the electronic device, untracked new traffic from the client, an operation of adding, by the electronic device, an entry corresponding to the new traffic; an operation of transmitting, by the electronic device, connection information corresponding to the entry to the external electronic device; and an operation of storing, by the external electronic device, the connection information, and synchronizing with the electronic device.

The cloud server may include an operation of processing the connection information through the external electronic device when the electronic device does not operate.

1. A method of an electronic device, comprising:
an operation of receiving, by a first eBPF module, untracked new traffic from a client;
an operation of adding, by the first eBPF module, an entry corresponding to the new traffic to a ConnTrack map in response to the operation of receiving the new traffic;
an operation of reporting, by the first eBPF module, the addition of the entry to a first synchronization module; and
an operation of monitoring, by the first synchronization module, a first connection corresponding to the new traffic.

2. The method of an electronic device of claim 1, wherein the electronic device includes an operation of transmitting information corresponding to the first connection to a second synchronization module of an external electronic device through the first synchronization module.

3. The method of an electronic device of claim 2, wherein the operation of adding the entry includes an operation of updating at least one of SIP, DIP, Sport, Dport, Protocol, or a state corresponding to the new traffic to the ConnTrack map.

4. The method of an electronic device of claim 3, wherein the operation of monitoring includes an operation of monitoring the first connection corresponding to the new traffic when the entry is maintained for a pre-designated time or more.

5. The method of an electronic device of claim 4, wherein the electronic device includes an operation of receiving information corresponding to a second connection of traffic different from the new traffic, from the second synchronization module of the external electronic device through the first synchronization module.

6. The method of an electronic device of claim 5, wherein the first synchronization module is positioned in a user plane, and the first eBPF module is positioned in a kernel plane.

7. The method of an electronic device of claim 6, wherein the pre-designated time is at least 10 seconds or more.

8. A method of an external electronic device, comprising:
an operation of receiving first connection information from a first synchronization module of an electronic device in a cluster through a second synchronization module of the external electronic device;
an operation of requesting, by the second synchronization module, a second eBPF module of the external electronic device to update the first connection information to a Conntrack map of the external electronic device; and
an operation of updating, by the second eBPF module, the first connection information to the Conntrack map.

9. A cluster system including a client, an electronic device, an external electronic device, and a cloud server, comprising:
an operation of receiving, by the electronic device, untracked new traffic from the client;
an operation of adding, by the electronic device, an entry corresponding to the new traffic;
an operation of transmitting, by the electronic device, connection information corresponding to the entry to the external electronic device; and
an operation of storing, by the external electronic device, the connection information, and synchronizing with the electronic device.

10. The cluster system of claim 9, wherein the cloud server includes an operation of processing the connection information through the external electronic device when the electronic device does not operate.
